(19) United States
(12) Patent Application Publication
(10) Pub. No.: US 2026/0319865 A1
(43) Pub. Date: Oct. 15, 2026

(54) METHOD FOR EVENT TRACKING PROCESSING, EVENT TRACKING PROCESSING DEVICE, AND COMPUTER-READABLE STORAGE MEDIUM

(71) Applicant: Beijing Volcano Engine Technology Co., Ltd., Beijing (CN)

(72) Inventors: Jiawei LI, Beijing (CN); Yongsheng ZHANG, Beijing (CN); Yong LIN, Beijing (CN); Xuan LUO, Beijing (CN)

(21) Appl. No.: 19/483,957

(22) PCT Filed: May 15, 2024
(86) PCT No.: PCT/CN2024/093330

§ 371 Date: Nov. 12, 2025

(30) Foreign Application Priority Data
May 15, 2023 (CN) 202310544822.5

(51) Int. Cl. G06F 9/54

(52) U.S. Cl. CPC G06F 9/542

(57) ABSTRACT

The present disclosure provides a method for event tracking processing, a device and a storage medium. And the method includes: acquiring an identification of a first element in response to a selection operation triggered for the first element in an event tracking configuration page; determining a plurality of second elements in a page to be analyzed according to the identification of the first element; and sending the identification of the first element, an identification of at least one second element in the plurality of second elements, and target configuration information configured in the event tracking configuration page to a server. so that the server generates an event tracking configuration file corresponding to the page to be analyzed according to the identification of the first element, the identification of the at least one second element, and the target configuration information.

This application claims priority to Chinese Patent Application No. 202310544822.5, filed on May 15, 2023, which is incorporated herein by reference in its entirety as part of this application.

### TECHNICAL FIELD

Embodiments of the present disclosure relate to a method for event tracking processing and an apparatus.

### BACKGROUND

Event tracking analysis is a common data collection method for website analysis. For a web application, a developer or an operation and maintenance person can write software code corresponding to an event tracking and run the software code on the web application, so as to collect running data corresponding to the web application.

However, the manner of writing software code corresponding to an event tracking to perform data collection requires a large amount of research and development and operation and maintenance costs. Writing software code corresponding to an event tracking requires a certain amount of research and development costs. In addition, when application logic of the web application changes, or event tracking data that needs to be collected changes, it is necessary to rewrite the software code corresponding to the event tracking, thereby consuming a large amount of operation and maintenance costs.

### SUMMARY

In order to solve or at least partially solve the above technical problems, embodiments of the present application provide a method for event tracking processing and apparatus.

Embodiments of the present disclosure provide a method for event tracking processing, the method includes:
acquiring an identification of a first element in response to a selection operation triggered for the first element in an event tracking configuration page, where the first element is an element in a page to be analyzed;
determining a plurality of second elements in the page to be analyzed according to the identification of the first element, where the second elements are elements of the equal type to the first element; and
sending the identification of the first element, an identification of at least one second element in the plurality of second elements, and target configuration information configured in the event tracking configuration page to a server, so that the server generates an event tracking configuration file corresponding to the page to be analyzed according to the identification of the first element, the identification of the at least one second element, and the target configuration information, where the event tracking configuration file is used to perform event tracking data collection on the page to be analyzed.

Optionally, the identification of the first element includes a path position of the first element, the path position includes path information and first position information, the path information indicates that an element path of the first element includes N levels, N is an integer greater than 1, and the first position information indicates a number corresponding to a tag name of the first element at each of the levels, where the N levels include a first level, the first level includes at least one element having the tag name, and a number corresponding to the tag name of the first element at the first level indicates a number of the first element among the at least one element having the tag name, and the determining the plurality of second elements in the page to be analyzed according to the identification of the first element includes:
replacing a first number in the first position information with a preset path wildcard to obtain second position information, where the preset path wildcard indicates that the first number is ignored; and
determining the plurality of second elements according to the second position information and the path information.

Optionally, the replacing the first number in the first position information with the preset path wildcard to obtain the second position information includes:
sequentially replacing, in a preset order, numbers corresponding to the respective levels in the N levels in the first position information with the preset path wildcard, to obtain the second position information corresponding to the respective levels, where the numbers corresponding to the respective levels in the first position information include the first number.

Optionally, the identification of the first element includes a first Cascading Style Sheets (CSS) selector of the first element, and the determining the plurality of second elements in the page to be analyzed according to the identification of the first element includes:
determining a candidate CSS selector according to the first CSS selector;
determining a relative CSS path between the first CSS selector and the candidate CSS selector; and
determining the plurality of second elements according to the candidate CSS selector and the relative CSS selector.

Optionally, the determining the candidate CSS selector according to the first CSS selector includes:
determining, through M rounds of iteration, the candidate CSS selector corresponding to each round of iteration, where M is an integer greater than 1; where:
in a first round of iteration, determining a first parent CSS selector of the first CSS selector as the candidate CSS selector corresponding to the first round of iteration; and
in an ith round of iteration, determining a CSS selector having an inheritance relationship with the candidate CSS selector determined in an (i-1)th round of iteration as the candidate CSS selector corresponding to the ith round of iteration, where i is an integer greater than 1 and less than or equal to M.

Optionally, the determining the plurality of second elements in the page to be analyzed according to the identification of the first element includes:
determining the plurality of second elements in the page to be analyzed according to the identification of the first element in response to an operation of automatically acquiring elements of the equal type triggered in the event tracking configuration page.

Optionally, the method further includes:
presenting the plurality of second elements; and
acquiring the identification of the at least one second element in response to a selection operation triggered for the at least one second element in the plurality of elements.

Optionally, the target configuration information includes one or more of the following:
an event type corresponding to the event tracking data collection, a trigger condition of the event tracking data collection, and an attribute value corresponding to an event tracking element, where the event tracking element includes the first element and the at least one second element.

Embodiments of the present disclosure provide a method for event tracking processing, the method includes:
receiving an event tracking configuration file sent by a server, where the event tracking configuration file is the event tracking configuration file according to any one of the above first aspect;
acquiring a target event in the page to be analyzed and matching the target event with the event tracking configuration file; and
when the target event is successfully matched with the event tracking configuration file, collecting event tracking data corresponding to the target event.

Embodiments of the present disclosure provide an event tracking processing apparatus, the apparatus includes:
a first acquiring unit, configured to acquire an identification of a first element in response to a selection operation triggered for the first element in an event tracking configuration page, where the first element is an element in a page to be analyzed;
a determining unit, configured to determine a plurality of second elements in the page to be analyzed according to the identification of the first element, where the second elements are elements of the equal type to the first element; and
a sending unit, configured to send the identification of the first element, an identification of at least one second element in the plurality of second elements, and target configuration information configured in the event tracking configuration page to a server, so that the server generates an event tracking configuration file corresponding to the page to be analyzed according to the identification of the first element, the identification of the at least one second element, and the target configuration information, where the event tracking configuration file is used to perform event tracking data collection on the page to be analyzed.

Optionally, the identification of the first element includes a path position of the first element, the path position includes path information and first position information, the path information indicates that an element path of the first element includes N levels, N is an integer greater than 1, and the first position information indicates a number corresponding to a tag name of the first element at each of the levels, where the N levels include a first level, the first level includes at least one element having the tag name, and a number corresponding to the tag name of the first element at the first level indicates a number of the first element among the at least one element having the tag name, and the determining unit is configured to:
replace a first number in the first position information with a preset path wildcard to obtain second position information, where the preset path wildcard indicates that the first number is ignored; and
determine the plurality of second elements according to the second position information and the path information.

Optionally, the replacing the first number in the first position information with the preset path wildcard to obtain the second position information includes:
sequentially replacing, in a preset order, numbers corresponding to the respective levels in the N levels in the first position information with the preset path wildcard, to obtain the second position information corresponding to the respective levels, where the numbers corresponding to the respective levels in the first position information include the first number.

Optionally, the identification of the first element includes a first Cascading Style Sheets (CSS) selector of the first element, and the determining unit is configured to:
determine a candidate CSS selector according to the first CSS selector;
determine a relative CSS path between the first CSS selector and the candidate CSS selector; and
determine the plurality of second elements according to the candidate CSS selector and the relative CSS selector.

Optionally, the determining the candidate CSS selector according to the first CSS selector includes:
determining, through M rounds of iteration, the candidate CSS selector corresponding to each round of iteration, where M is an integer greater than 1; where:
in a first round of iteration, determining a first parent CSS selector of the first CSS selector as the candidate CSS selector corresponding to the first round of iteration; and
in an ith round of iteration, determining a CSS selector having an inheritance relationship with the candidate CSS selector determined in an (i-1)th round of iteration as the candidate CSS selector corresponding to the ith round of iteration, where i is an integer greater than 1 and less than or equal to M.

Optionally, the determining unit is configured to:
determine the plurality of second elements in the page to be analyzed according to the identification of the first element in response to an operation of automatically acquiring elements of the equal type triggered in the event tracking configuration page.

Optionally, the apparatus further includes:
a presenting unit, configured to present the plurality of second elements; and
a second acquiring unit, configured to acquire the identification of the at least one second element in response to a selection operation triggered for the at least one second element in the plurality of elements.

Optionally, the target configuration information includes one or more of the following:
an event type corresponding to the event tracking data collection, a trigger condition of the event tracking data collection, and an attribute value corresponding to an event tracking element, where the event tracking element includes the first element and the at least one second element.

Embodiments of the present disclosure provide an event tracking processing apparatus, the apparatus includes:
a receiving unit, configured to receive an event tracking configuration file sent by a server, where the event tracking configuration file is the event tracking configuration file according to any one of the above first aspect;
an acquiring unit, configured to acquire a target event in the page to be analyzed and match the target event with the event tracking configuration file; and
a collecting unit, configured to collect event tracking data corresponding to the target event when the target event is successfully matched with the event tracking configuration file.

Embodiments of the present disclosure provide an event tracking processing device, the device includes a processor and a memory;
the processor is configured to execute instructions stored in the memory, to enable the device to execute the method according to any one of the above first aspect, or to enable the device to execute the method according to the above second aspect.

Embodiments of the present disclosure provide a computer-readable storage medium, including instructions, where the instructions instruct a device to execute the method according to any one of the above first aspect, or the instructions instruct the device to execute the method according to the above second aspect.

Embodiments of the present disclosure provide a computer program product, when the computer program product is run on a computer, the computer is caused to execute the method according to any one of the above first aspect, or the computer is caused to execute the method according to the above second aspect.

### BRIEF DESCRIPTION OF DRAWINGS

In order to more clearly illustrate the technical solutions in the embodiments of the present disclosure or in the prior art, the following will briefly introduce the drawings that need to be used in the description of the embodiments or the prior art. Obviously, the drawings in the following description are only some embodiments of the present disclosure, and for those of ordinary skill in the art, other drawings can also be obtained according to these drawings without paying creative labor.

FIG. 1 is a schematic diagram of an exemplary application scenario provided by an embodiment of the present disclosure;

FIG. 2 is a schematic flowchart of a method for event tracking processing provided by an embodiment of the present disclosure;

FIG. 3 is a schematic flowchart of a method for determining a second element provided by an embodiment of the present disclosure;

FIG. 4 is a schematic diagram of a Document Object Model (DOM) structure of a page to be analyzed provided by an embodiment of the present disclosure;

FIG. 5 is a schematic flowchart of another method for determining a second element provided by an embodiment of the present disclosure;

FIG. 6 is a schematic diagram of a Document Object Model (DOM) structure of a page to be analyzed provided by an embodiment of the present disclosure;

FIG. 7 is a schematic flowchart of a method for event tracking processing provided by an embodiment of the present disclosure;

FIG. 8 is a schematic structural diagram of an event tracking processing apparatus provided by an embodiment of the present disclosure; and

FIG. 9 is a schematic structural diagram of another event tracking processing apparatus provided by an embodiment of the present disclosure.

### DETAILED DESCRIPTION

In order to enable those skilled in the art to better understand the solutions of the present disclosure, the technical solutions in the embodiments of the present disclosure will be described clearly and completely below with reference to the drawings in the embodiments of the present disclosure. Obviously, the described embodiments are only a part of the embodiments of the present disclosure, but not all embodiments. Based on the embodiments in the present disclosure, all other embodiments obtained by those of ordinary skill in the art without creative efforts shall fall within the protection scope of the present disclosure.

Embodiments of the present disclosure provide a method for event tracking processing. In an example, the method can be applied to a first client. The first client can present an event tracking configuration page, and a first element in a page to be analyzed can be presented in the event tracking configuration page. The user can trigger a selection operation for the first element in the event tracking configuration page. Correspondingly, the first client can acquire an identification of the first element in response to the selection operation triggered for the first element. Furthermore, a plurality of second elements in the page to be analyzed are determined according to the identification of the first element, where the second elements are elements of the equal type to the first element. Furthermore, the identification of the first element, an identification of at least one second element in the plurality of second elements, and target configuration information configured in the event tracking configuration page are sent to a server, so that the server generates an event tracking configuration file corresponding to the page to be analyzed according to the identification of the first element, the identification of the at least one second element, and the target configuration information. The event tracking configuration file is used to perform event tracking data collection on the page to be analyzed. It can be seen that, with this solution, the user can select the first element in the event tracking configuration page. After the user selects the first element, the first client can automatically obtain a plurality of elements of the equal type to the first element, so that the server can generate the event tracking configuration file for performing event tracking data collection on the page to be analyzed according to the first element, the at least one second element, and the target configuration information configured in the event tracking configuration page. With this solution, there is no need for the user to write corresponding software code, and the corresponding configuration can be performed in the visual event tracking configuration page. Moreover, for elements of the equal type, the user only needs to select one of the elements (the first element) in the event tracking configuration page, which effectively reduces the research and development and operation and maintenance costs of performing event tracking analysis on the page to be analyzed.

Accordingly, the second client can receive the aforementioned event tracking configuration file sent by the server. The event tracking analysis is performed on the page to be analyzed by using the event tracking configuration file. In a specific example, the second client can acquire the target event in the page to be analyzed and match the target event with the event tracking configuration file. If the target event is successfully matched with the event tracking configuration file, the second client can collect the event tracking data corresponding to the target event. With this solution, the event tracking analysis of the page to be analyzed can be realized with less research and development and operation and maintenance costs.

Various non-restrictive implementations of the present disclosure are described in detail below with reference to the drawings.

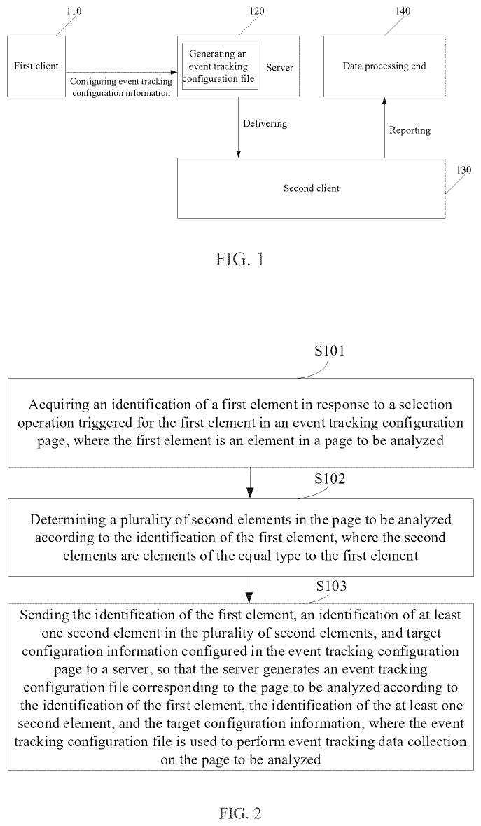

Referring to FIG. 1, FIG. 1 is a schematic diagram of an exemplary application scenario provided by an embodiment of the present disclosure. As shown in FIG. 1, a first client 110 can interact with a server 120. The user can configure event tracking configuration information on the first client 110. Correspondingly, the server 120 generates a corresponding event tracking configuration file based on the event tracking configuration information configured by the user on the first client 110, and delivers the event tracking configuration file to a second client 130. The second client can collect event tracking data based on the event tracking configuration file, and report the collected event tracking data to a data processing end 140.

Next, the method for event tracking processing provided by the embodiments of the present disclosure is introduced.

Referring to FIG. 2, it is a schematic flowchart of a method for event tracking processing provided by an embodiment of the present disclosure. The method for event tracking processing shown in FIG. 2 can be applied to a first client. In this embodiment, the method for event tracking processing may include the following steps, for example: S101-S103.
S101, acquiring an identification of a first element in response to a selection operation triggered for the first element in an event tracking configuration page, where the first element is an element in a page to be analyzed.

The first client can present an event tracking configuration page, which can be a page corresponding to an event tracking configuration platform. The user can configure event tracking configuration information of the page to be analyzed in a visual manner by using the event tracking configuration platform, so as to facilitate event tracking data collection on the page to be analyzed.

In the embodiment of the present disclosure, at least one page element in the page to be analyzed can be presented in the event tracking configuration page. For example, the page to be analyzed is presented in the event tracking configuration page, or at least one page element that supports event tracking in the page to be analyzed is presented in the event tracking configuration page. The at least one page element can include the first element, or the first element can be one of the at least one page element.

In the embodiment of the present disclosure, the user can trigger the selection operation for the first element in the event tracking configuration page. The specific implementation of triggering the selection operation for the first element by the user is not specifically limited in the embodiment of the present disclosure. For example, the user can circle the first element in the event tracking configuration page, or the user can trigger a double-click operation for the first element in the event tracking configuration page, and so on, which will not be listed here.

After the user triggers the selection operation for the first element, the first client can acquire the identification of the first element in response to the selection operation triggered for the first element. The identification of the first element is used to uniquely identify the first element in the page to be analyzed.

In an example, the identification of the first element can be a path position of the first element. The path position can include path information and first position information. Where:
the path information is used to indicate an element path of the first element. In an example, the element path of the first element can include N levels, and N is an integer greater than 1. For example, the element path of the first element is: /body/ . . . /tbody/tr/td/div/span, where span is a tag name of the first element.
the first position information is used to indicate a number corresponding to the tag name of the first element at each of the levels. Taking the first level in the plurality of levels as an example, the first level can include at least one element with a tag name, and the number corresponding to the tag name of the first element at the first level can be the number of the first element among the at least one element having the tag name included in the first level. For example, if the first level includes only one element with a tag name, that is, there is no other element with the equal tag name to the first element at the first level, the number corresponding to the tag name of the first element at the first level can be 0. For another example, if the first level includes two elements with tag names, that is, there is another element with the equal tag name to the first element at the first level, the number corresponding to the tag name of the first element at the first level can be 0 or 1. In the case where the element path of the first element is: /body/ . . . /tbody/tr/td/div/span, the first position information can be, for example: [‘0’, . . . , ‘0’, ‘1’, ‘3’, ‘0’, ‘0’].

In another example, the identification of the first element can be a first Cascading Style Sheets selector (CSS selector) of the first element.

In an example, considering the web page, it is more appropriate for some web pages to use the path position as the identification of the page element, while for other web pages, it is more appropriate to use the CSS selector as the identification of the element. Therefore, in an example, the first client can acquire the path position and the first CSS selector of the first element, present the path position and the first CSS selector of the first element, and the user selects one of the path position and the first CSS selector of the first element as the identification of the first element.
S102, determining a plurality of second elements in the page to be analyzed according to the identification of the first element, where the second elements are elements of the equal type to the first element.

In the embodiment of the present disclosure, considering that the page to be analyzed may include many elements of the equal type, and in some scenarios, the user's requirements for event tracking of elements of the equal type are the equal or similar. Therefore, in the embodiment of the present disclosure, in order to improve the efficiency of the user in setting the event tracking configuration information, after the user triggers the selection operation for the first element, the first client can automatically acquire the elements of the equal type to the first element in the page to be analyzed according to the identification of the first element to obtain a plurality of second elements, without the user triggering the selection operation for the elements of the equal type to the first element one by one in the event tracking configuration page.

In an example, the first client can enable the “automatically acquiring elements of the equal type” function by default. In this case, after acquiring the identification of the first element, the first client can determine the plurality of second elements according to the identification of the first element.

In another example, it can be determined by the user whether to enable the “automatically acquiring elements of the equal type” function. In a specific example, the user can trigger an operation of automatically acquiring elements of the equal type in the event tracking configuration page. Correspondingly, after acquiring the identification of the first element, the first client can further determine the plurality of second elements in response to the operation of automatically acquiring elements of the equal type. The user triggering the operation of automatically acquiring elements of the equal type in the event tracking configuration page can be understood as that the user enables the aforementioned “automatically acquiring elements of the equal type” function.

As mentioned above, the identification of the first element can be the path position of the first element or the first CSS selector of the first element. When the identification of the first element is the path position of the first element, the specific implementation of S102 can be referred to the description of S1021-S1022 below, which will not be described in detail here. When the identification of the first element is the first CSS selector of the first element, the specific implementation of S102 can be referred to the specific description of S1023-S1025 below, which will not be described in detail here.
S103, sending the identification of the first element, an identification of at least one second element in the plurality of second elements, and target configuration information configured in the event tracking configuration page to a server, so that the server generates an event tracking configuration file corresponding to the page to be analyzed according to the identification of the first element, the identification of the at least one second element, and the target configuration information, where the event tracking configuration file is used to perform event tracking data collection on the page to be analyzed.

In an example, after determining the plurality of second elements, the first client can present the plurality of second elements, and the user selects at least one second element that actually needs event tracking from the plurality of second elements, so as to meet the user's personalized event tracking requirements.

As mentioned above, at least one page element in the page to be analyzed can be presented in the event tracking configuration page. In an example, when specifically implementing the presentation of the plurality of elements, the first client can present the plurality of second elements in a specific style, where the specific style is different from the presentation styles of other page elements in the at least one page element. For example, a selection mark (for example, a box) is presented on the periphery of the plurality of second elements. Correspondingly, the user can select at least one second element from the plurality of second elements presented in the specific style.

In another example, the first client can present at least one combination of elements of the equal type in a drop-down menu, where each combination can include at least one second element. In a specific example, the user can trigger a first operation (for example, a click operation) in an input area of elements of the equal type, and the first client can present at least one combination of elements of the equal type (for example, present the name of the at least one combination of elements of the equal type) in a drop-down menu in response to the first operation. The user can trigger a second operation (for example, a hover operation or a single-click operation) for a first combination of elements of the equal type in the at least one combination of elements of the equal type, and the first client can present the second element included in the first combination of elements of the equal type in a specific style, so that the user can determine which second elements are included in the first combination of elements of the equal type. Correspondingly, the user can select one or more combinations from the drop-down menu, thereby selecting at least one second element.

Regarding the first combination of elements of the equal type, it should be noted that the first combination of elements of the equal type can include one or more second elements. If the plurality of second elements are determined by using S1021-S1022 mentioned below, the second element in the first combination of elements of the equal type can be determined according to the second position information corresponding to a certain level. When the plurality of second elements are determined by using S1023-S1025 mentioned below, the second element in the first combination of elements of the equal type can be determined according to the candidate CSS selector determined in a certain round of iteration.

After determining the at least one second element, the first client can acquire the identification of the second element. The identification of the second element can be referred to the description of the identification of the first element above, and will not be repeated here.

In the embodiment of the present disclosure, in addition to selecting the first element in the event tracking configuration page, the user can also input other configuration information in the event tracking configuration page. In an example, the user can also input the target configuration information in the event tracking configuration page. The target configuration information is other configuration information for performing event tracking data collection on the page to be analyzed. Correspondingly, the first client can acquire the target configuration information.

As an example, the target configuration information can include one or more of the following: an event type corresponding to the event tracking data collection, a trigger condition of the event tracking data collection, and an attribute value corresponding to an event tracking element. Where:
the event type can include any event type that occurs on a web page, for example, the event type can include a click event, an exposure event, a browsing event, and so on.
the trigger condition can be a condition that needs to be satisfied for performing event tracking data collection. For example, the trigger condition can include collecting data corresponding to a specific Uniform Resource Locator (URL). For another example, the trigger condition can include collecting the corresponding event tracking data only when the dwell time exceeds a preset time threshold, and so on, which will not be listed here.

The attribute value corresponding to the event tracking element can be determined according to an actual business scenario. In a specific example, the attribute value corresponding to the event tracking element may include a text corresponding to the event tracking element, a preset system variable, and business information. The preset system variable is not specifically limited in the embodiment of the present disclosure, and the preset system variable includes but is not limited to one or more of the following: a time stamp, a text title, and a page URL. The business information can be acquired through a business interface, for example, a business request sent or received through the business interface can be acquired, and data such as a request method, a URL, a request body, and a response body included in the business request is determined as the business information.

After acquiring the identification of the first element, the identification of the at least one second element, and the target configuration information, the first client can send the identification of the first element, the identification of the at least one second element, and the target configuration information to the server. After receiving the identification of the first element, the identification of the at least one second element, and the target configuration information sent by the first client, the server can generate the event tracking configuration file corresponding to the page to be analyzed according to the identification of the first element, the identification of the at least one second element, and the target configuration information. The event tracking configuration file is used to perform event tracking data collection on the page to be analyzed. In an example, the server can generate the event tracking configuration file in a specific format according to the identification of the first element, the identification of the at least one second element, and the target configuration information. The event tracking configuration file includes the identification of the first element, the identification of the at least one second element, and the target configuration information.

In an example, after generating the event tracking configuration file, the server can send the event tracking configuration file to the second client, so that the second client can perform event tracking data collection on the page to be analyzed by using the event tracking configuration file.

It can be seen from the above description that, with this solution, there is no need for the user to write corresponding software code, and the corresponding configuration can be performed in the visual event tracking configuration page. Moreover, for elements of the equal type, the user only needs to select one of the elements (the first element) in the event tracking configuration page, which effectively reduces the research and development and operation and maintenance costs of performing event tracking analysis on the page to be analyzed.

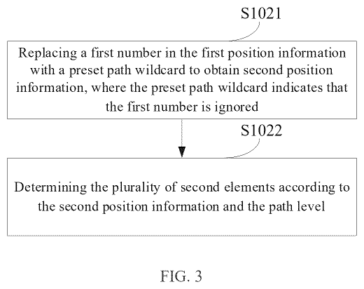

Next, two implementations of S102 are introduced with reference to FIG. 3 to FIG. 6.

Referring to FIG. 3, it is a schematic flowchart of a method for determining a second element provided by an embodiment of the present disclosure. The method shown in FIG. 3 may include the following S1021-S1022, for example.
S1021, replacing a first number in the first position information with a preset path wildcard to obtain second position information, where the preset path wildcard indicates that the first number is ignored.

As mentioned above, the element path of the first element includes N levels, therefore, the first position information includes N numbers, and the first number may be one of the N numbers.

In an example, one number can be randomly selected from the N numbers as the first number.

In another example, in order to determine as many elements of the equal type to the first element as possible, numbers corresponding to the respective levels in the N levels in the first position information can be sequentially replaced with the preset path wildcard in a preset order, to obtain the second position information corresponding to the respective levels. The preset order is not specifically limited in the embodiment of the present disclosure, and the preset order can be an order from a low level to a high level, or an order from a high level to a low level.

In the embodiment of the present disclosure, the preset path wildcard is used to indicate that the first number is ignored. In an example, the preset wildcard can be the character “*”.
S1022, determining the plurality of second elements according to the second position information and the path level.

After determining the second position information and the path level, the plurality of second elements can be determined according to the second position information and the path level. Specifically, elements in the page to be analyzed can be traversed, and an element whose element path is the same as the element path of the first element and whose position information is the second position information is determined as the second element.

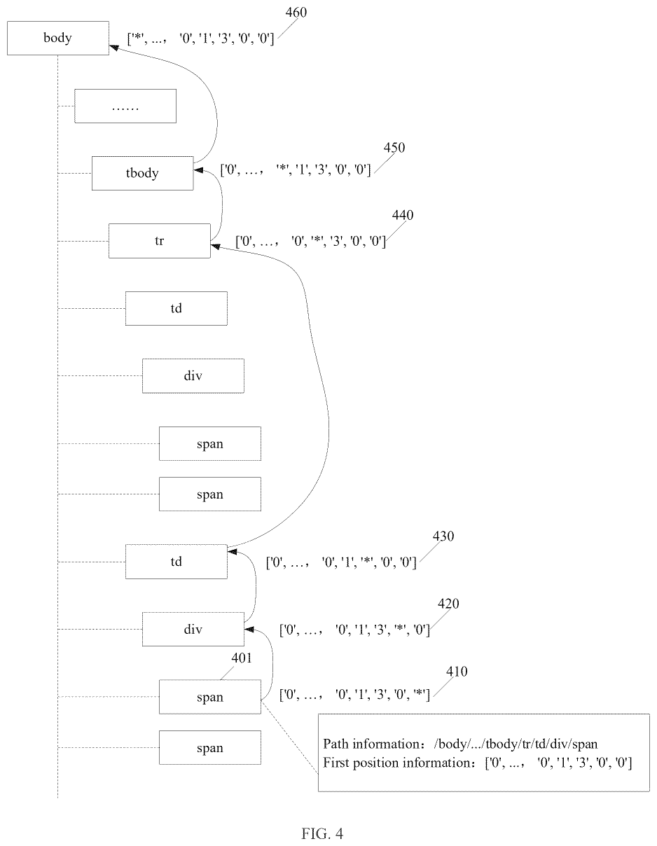

Regarding S1021-S1022, an example is described below with reference to FIG. 4.

As shown in FIG. 4, it is a schematic diagram of a Document Object Model (DOM) structure of a page to be analyzed provided by an embodiment of the present disclosure. The first element corresponds to node 401, the path information of the first element is: /body/ . . . /tbody/tr/td/div/span, and the first position information is [‘0’, . . . , ‘0’, ‘1’, ‘3’, ‘0’, ‘0’]. The second position information corresponding to the respective levels is obtained in an order from a low level to a high level. As shown in FIG. 4, the second position information 410, 420, 430, 440, 450, and 460 can be obtained, and at least one second element is obtained according to the position information and the path information corresponding to the respective levels.

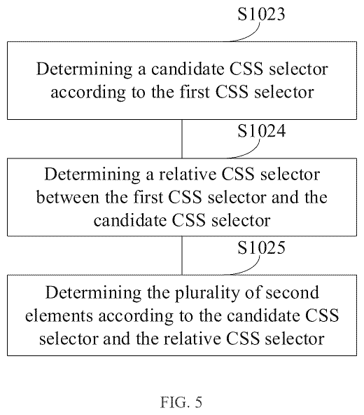

Referring to FIG. 5, it is a schematic flowchart of another method for determining a second element provided by an embodiment of the present disclosure. The method shown in FIG. 5 may include the following S1023-S1025, for example.
S1023, determining a candidate CSS selector according to the first CSS selector.

In an example, a CSS selector having an inheritance relationship with the first CSS selector can be determined as the candidate CSS selector. The CSS selector having an inheritance relationship with the first CSS selector mentioned here refers to a CSS selector having a direct or indirect parent-child relationship with the first CSS selector. For example, a first parent CSS selector of the first CSS selector can be determined as the candidate CSS selector. For another example, a second parent CSS selector of the first parent CSS selector or a third parent CSS selector of the second parent CSS selector can be determined as the candidate CSS selector.

In another example, in order to determine as many elements of the equal type to the first element as possible, the candidate CSS selector corresponding to each round of iteration can be determined through M rounds of iteration. M is an integer greater than 1. Where:
in a first round of iteration, a parent CSS selector of the first CSS selector can be determined as the candidate CSS selector corresponding to the first round of iteration.

In an ith round of iteration, the candidate CSS selector corresponding to the ith round of iteration can be determined according to the candidate CSS selector determined in an (i-1)th round of iteration. In an example, a CSS selector having an inheritance relationship with the candidate CSS selector corresponding to the (i-1)th round of iteration can be determined as the candidate CSS selector corresponding to the ith round of iteration. Where, i is an integer greater than 1 and less than or equal to M.
S1024, determining a relative CSS selector between the first CSS selector and the candidate CSS selector.

After determining the candidate CSS selector, the relative path calculation can be performed according to the first CSS selector and the candidate CSS selector to obtain the relative CSS selector. The relative CSS selector may also be referred to as a relative fragment selector.
S1025, determining the plurality of second elements according to the candidate CSS selector and the relative CSS selector.

After determining the relative CSS selector, at least one second CSS selector whose relative path to the candidate CSS selector is the relative CSS selector can be determined according to the candidate CSS selector and the relative CSS selector, and an element corresponding to the at least one second CSS selector is determined as the second element, so as to obtain the plurality of second elements.

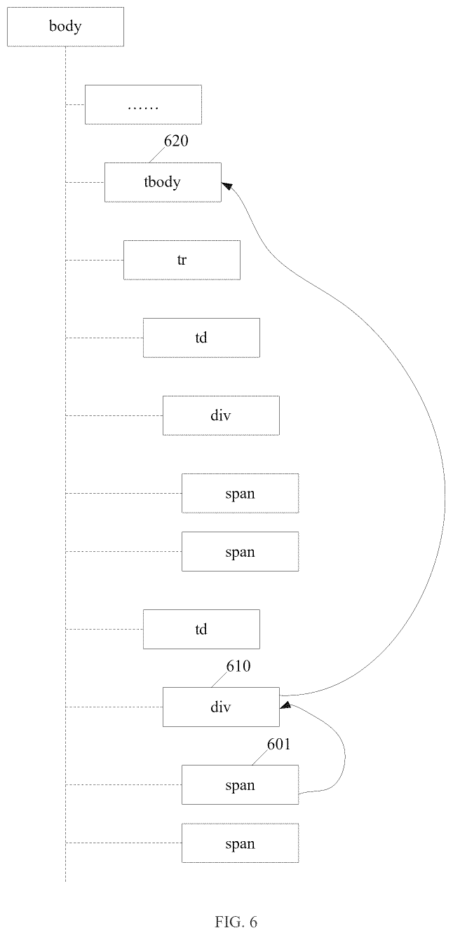

Regarding S1023-S1025, an example is described below with reference to FIG. 6, which also shows a schematic diagram of a document object model (DOM) structure of a page to be analyzed.

As shown in FIG. 6, the first element corresponds to node 601 shown in FIG. 6. In the first round of iteration, the parent CSS selector of the first CSS selector is determined as the candidate CSS selector. Correspondingly, the second element is determined according to the candidate CSS selector corresponding to the first round of iteration. The parent CSS selector of the first CSS selector corresponds to node 610 shown in FIG. 6.

In the second round of iteration, the CSS selector corresponding to node 620 is determined as the candidate CSS selector according to the CSS selector of node 610. Correspondingly, the second element is determined according to the candidate CSS selector corresponding to the second round of iteration.

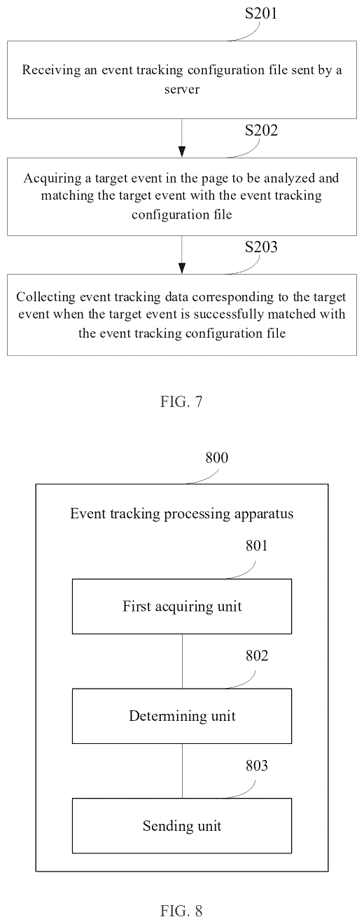

Next, a specific implementation of performing event tracking data collection on the page to be analyzed by the second server is introduced. Referring to FIG. 7, it is a schematic flowchart of a method for event tracking processing provided by an embodiment of the present disclosure. The method shown in FIG. 7 can be applied to a second client. In an example, the method may include the following S201-S203, for example.
S201, receiving an event tracking configuration file sent by a server.

Regarding the event tracking configuration file, reference can be made to the foregoing related description, which will not be repeated here.
S202, acquiring a target event in the page to be analyzed and matching the target event with the event tracking configuration file.
S203, collecting event tracking data corresponding to the target event when the target event is successfully matched with the event tracking configuration file.

In an example, the second client can acquire an event that occurs in the page to be analyzed by using a corresponding event acquiring instance. After acquiring the target event in the page to be analyzed, the target event can be matched with the event tracking configuration file. In an example, the second client can traverse the configuration information in the event tracking configuration file one by one, and match the configuration information with the target event. As an example, an event type corresponding to the event tracking data collection in the configuration information is matched with the target event. If the event type included in the configuration information includes the event type of the target event, it can be further determined whether the trigger condition included in the configuration information is satisfied. In the case where the trigger condition is satisfied, it can be determined that the target event is successfully matched with the event tracking configuration file. Otherwise, it can be determined that the target event is failed to match with the event tracking configuration file.

After determining that the target event is successfully matched with the event tracking configuration file, the event tracking data corresponding to the target event can be further collected. In an example, the event tracking data that needs to be collected can be determined according to the attribute value of the event tracking element corresponding to the target event in the event tracking configuration file, and the event tracking data is further collected.

In an example, after collecting the event tracking data, the second client can report the event tracking data to another data processing end, and the data processing end processes the event tracking data. The data processing end mentioned here can be a data warehouse for storing data, or a server for analyzing data, which is not specifically limited in the embodiment of the present disclosure.

Next, taking an exposure event as an example, a specific implementation of S202-S203 is introduced.

The second client cyclically traverses the event tracking information in the event tracking configuration file by using a first callback function, the event tracking information includes the identification of the first element, and parses a DOM instance corresponding to the first element, and determines, according to a second callback function, whether the DOM instance corresponding to the first element is exposed. If the DOM instance corresponding to the first element is exposed, it is further determined whether other trigger conditions corresponding to the first element are satisfied, for example, whether one or more factors such as a URL, an exposure frequency, an exposure duration, and an exposure proportion are satisfied. In the case where the other trigger conditions are satisfied, data corresponding to the first element is collected according to the attribute value of the first element, and the data is reported to the data processing end.

Based on the method provided by the above embodiments, an embodiment of the present disclosure further provides an apparatus, which is introduced below with reference to the drawings.

Referring to FIG. 8, it is a schematic structural diagram of an event tracking processing apparatus provided by an embodiment of the present disclosure. The apparatus 800 shown in FIG. 8 includes a first acquiring unit 801, a determining unit 802, and a sending unit 803.

The first acquiring unit 801 is configured to acquire an identification of a first element in response to a selection operation triggered for the first element in an event tracking configuration page, where the first element is an element in a page to be analyzed.

The determining unit 802 is configured to determine a plurality of second elements in the page to be analyzed according to the identification of the first element, where the second elements are elements of the equal type to the first element.

The sending unit 803 is configured to send the identification of the first element, an identification of at least one second element in the plurality of second elements, and target configuration information configured in the event tracking configuration page to a server, so that the server generates an event tracking configuration file corresponding to the page to be analyzed according to the identification of the first element, the identification of the at least one second element, and the target configuration information, where the event tracking configuration file is used to perform event tracking data collection on the page to be analyzed.

Optionally, the identification of the first element includes a path position of the first element, the path position includes path information and first position information, the path information indicates that an element path of the first element includes N levels, N is an integer greater than 1, and the first position information indicates a number corresponding to a tag name of the first element at each of the levels, where the N levels include a first level, the first level includes at least one element having the tag name, and a number corresponding to the tag name of the first element at the first level indicates a number of the first element among the at least one element having the tag name, and the determining unit 802 is configured to:
replace a first number in the first position information with a preset path wildcard to obtain second position information, where the preset path wildcard indicates that the first number is ignored; and determine the plurality of second elements according to the second position information and the path information.

Optionally, the replacing the first number in the first position information with the preset path wildcard to obtain the second position information includes:
sequentially replacing, in a preset order, numbers corresponding to the respective levels in the N levels in the first position information with the preset path wildcard, to obtain the second position information corresponding to the respective levels, where the numbers corresponding to the respective levels in the first position information include the first number.

Optionally, the identification of the first element includes a first Cascading Style Sheets (CSS) selector of the first element, and the determining unit 802 is configured to:
determine a candidate CSS selector according to the first CSS selector;
determine a relative CSS path between the first CSS selector and the candidate CSS selector; and
determine the plurality of second elements according to the candidate CSS selector and the relative CSS selector.

Optionally, the determining the candidate CSS selector according to the first CSS selector includes:
determining, through M rounds of iteration, the candidate CSS selector corresponding to each round of iteration, where M is an integer greater than 1; where:
in a first round of iteration, determining a first parent CSS selector of the first CSS selector as the candidate CSS selector corresponding to the first round of iteration; and
in an ith round of iteration, determining a CSS selector having an inheritance relationship with the candidate CSS selector determined in an (i-1)th round of iteration as the candidate CSS selector corresponding to the ith round of iteration, where i is an integer greater than 1 and less than or equal to M.

Optionally, the determining unit 802 is configured to:
determine the plurality of second elements in the page to be analyzed according to the identification of the first element in response to an operation of automatically acquiring elements of the equal type triggered in the event tracking configuration page.

Optionally, the apparatus 800 further includes:
a presenting unit, configured to present the plurality of second elements; and
a second acquiring unit, configured to acquire the identification of the at least one second element in response to a selection operation triggered for the at least one second element in the plurality of elements.

Optionally, the target configuration information includes one or more of the following:
an event type corresponding to the event tracking data collection, a trigger condition of the event tracking data collection, and an attribute value corresponding to an event tracking element, where the event tracking element includes the first element and the at least one second element.

Since the apparatus 800 is an apparatus corresponding to the method for event tracking processing executed by the first client provided by the above method embodiment, the specific implementations of the units of the apparatus 800 are the same as those of the above method embodiment. Therefore, regarding the specific implementations of the units of the apparatus 800, reference can be made to the related description of the above method embodiment, which will not be repeated here.

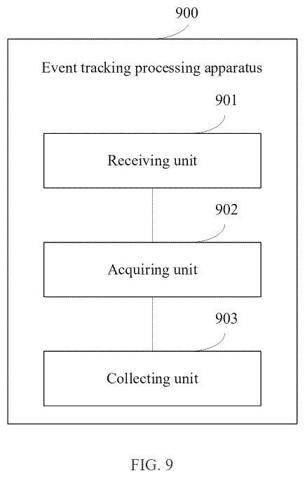

Referring to FIG. 9, it is a schematic structural diagram of another event tracking processing apparatus provided by an embodiment of the present disclosure. The apparatus 900 includes a receiving unit 901, an acquiring unit 902, and a collecting unit 903.

The receiving unit 901 is configured to receive an event tracking configuration file sent by a server, where the event tracking configuration file is the event tracking configuration file in the above method embodiment.

The acquiring unit 902 is configured to acquire a target event in the page to be analyzed and match the target event with the event tracking configuration file.

The collecting unit 903 is configured to collect event tracking data corresponding to the target event when the target event is successfully matched with the event tracking configuration file.

Since the apparatus 900 is an apparatus corresponding to the method for event tracking processing executed by the second client provided by the above method embodiment, the specific implementations of the units of the apparatus 900 are the same as those of the above method embodiment. Therefore, regarding the specific implementations of the units of the apparatus 900, reference can be made to the related description of the above method embodiment, which will not be repeated here.

The embodiments of the present disclosure further provide an event tracking processing device, and the event tracking processing device includes a processor and a memory;
the processor is configured to execute instructions stored in the memory, to enable the device to execute the method for event tracking processing provided by the above method embodiments. For example, the device can be enabled to execute the method for event tracking processing executed by the first client provided by the above method embodiments. For another example, the device can be enabled to execute the method for event tracking processing executed by the second client provided by the above method embodiments.

The embodiments of the present disclosure provide a computer-readable storage medium, including instructions, and the instructions instruct a device to execute the method for event tracking processing provided by the above method embodiments. For example, the instructions instruct the device to execute the method for event tracking processing executed by the first client provided by the above method embodiments. For another example, the instructions instruct the device to execute the method for event tracking processing executed by the second client provided by the above method embodiments.

The embodiments of the present disclosure further provide a computer program product, and when the computer program product is run on a computer, the computer is caused to execute the method for event tracking processing provided by the above method embodiments. For example, the computer is caused to execute the method for event tracking processing executed by the first client provided by the above method embodiments. For another example, the computer is caused to execute the method for event tracking processing executed by the second client provided by the above method embodiments.

Other implementations of the present disclosure will be readily apparent to those skilled in the art from consideration of the specification and practice of the embodiments disclosed herein. The present disclosure is intended to cover any variations, uses, or adaptations of the present disclosure that follow the general principles of the present disclosure and include common knowledge or conventional techniques in the art that are not disclosed in the present disclosure. The specification and the embodiments are to be considered as exemplary only, and the true scope and spirit of the present disclosure are indicated by the following claims.

It should be understood that the present disclosure is not limited to the precise structures that have been described above and shown in the drawings, and various modifications and changes can be made without departing from the scope thereof. The scope of the present disclosure is limited only by the appended claims.

The above are only preferred embodiments of the present disclosure and are not intended to limit the present disclosure. Any modifications, equivalent replacements, improvements, etc. made within the spirit and principles of the present disclosure shall be included in the protection scope of the present disclosure.

1. A method for event tracking processing, comprising:
acquiring an identification of a first element in response to a selection operation triggered for the first element in an event tracking configuration page, wherein the first element is an element in a page to be analyzed;
determining a plurality of second elements in the page to be analyzed according to the identification of the first element, wherein the second elements are elements of the equal type to the first element; and
sending the identification of the first element, an identification of at least one second element in the plurality of second elements, and target configuration information configured in the event tracking configuration page to a server, so that the server generates an event tracking configuration file corresponding to the page to be analyzed according to the identification of the first element, the identification of the at least one second element, and the target configuration information, wherein the event tracking configuration file is used to perform event tracking data collection on the page to be analyzed.

2. The method according to claim 1, wherein the identification of the first element comprises a path position of the first element, the path position comprises path information and first position information, the path information indicates that an element path of the first element comprises N levels, N is an integer greater than 1, and the first position information indicates a number corresponding to a tag name of the first element at each level,
wherein the N levels comprise a first level, the first level comprises at least one element having the tag name, and a number corresponding to the tag name of the first element at the first level indicates a number of the first element among the at least one element having the tag name, and the determining a plurality of second elements in the page to be analyzed according to the identification of the first element comprises:
replacing a first number in the first position information with a preset path wildcard to obtain second position information, wherein the preset path wildcard indicates that the first number is ignored; and
determining the plurality of second elements according to the second position information and the path information.

3. The method according to claim 2, wherein the replacing a first number in the first position information with a preset path wildcard to obtain second position information comprises:
sequentially replacing, in a preset order, numbers corresponding to respective levels in the N levels in the first position information with the preset path wildcard, to obtain the second position information corresponding to the respective levels, wherein the numbers corresponding to the respective levels in the first position information comprise the first number.

4. The method according to claim 1, wherein the identification of the first element comprises a first cascading style sheets (CSS) selector of the first element, and the determining a plurality of second elements in the page to be analyzed according to the identification of the first element comprises:
determining a candidate CSS selector according to the first CSS selector;
determining a relative CSS path between the first CSS selector and the candidate CSS selector; and
determining the plurality of second elements according to the candidate CSS selector and the relative CSS selector.

5. The method according to claim 4, wherein the determining a candidate CSS selector according to the first CSS selector comprises:
determining, through M rounds of iteration, a candidate CSS selector corresponding to each round of iteration, M is an integer greater than 1,
wherein, in a first round of iteration, determining a first parent CSS selector of the first CSS selector as a candidate CSS selector corresponding to the first round of iteration; and
in an ith round of iteration, determining a CSS selector having an inheritance relationship with a candidate CSS selector determined in an (i-1)th round of iteration as a candidate CSS selector corresponding to the ith round of iteration, wherein i is an integer greater than 1 and less than or equal to M.

6. The method according to claim 1, wherein the determining a plurality of second elements in the page to be analyzed according to the identification of the first element comprises:
determining the plurality of second elements in the page to be analyzed according to the identification of the first element, in response to an operation of automatically acquiring an element of an equal type triggered in the event tracking configuration page.

7. The method according to claim 1, further comprising:
presenting the plurality of second elements; and
acquiring an identification of the at least one second element in response to a selection operation triggered for the at least one second element in the plurality of elements.

8. The method according to claim 1, wherein the target configuration information comprises one or more of the following:
an event type corresponding to the event tracking data collection, a trigger condition of the event tracking data collection, and an attribute value corresponding to an event tracking element, wherein the event tracking element comprises the first element and the at least one second element.

9. A method for event tracking processing, comprising:
receiving an event tracking configuration file sent by a server, wherein the event tracking configuration file is the event tracking configuration file according to claim 1;
acquiring a target event in a page to be analyzed and matching the target event with the event tracking configuration file; and
collecting event tracking data corresponding to the target event in response to the target event being successfully matched with the event tracking configuration file.

10. (canceled)

11. (canceled)

12. An event tracking processing device, comprising a processor and a memory;
wherein, the processor is configured to execute instructions stored in the memory, to enable the device to execute a method for event tracking processing, wherein the method comprises:
acquiring an identification of a first element in response to a selection operation triggered for the first element in an event tracking configuration page, wherein the first element is an element in a page to be analyzed;
determining a plurality of second elements in the page to be analyzed according to the identification of the first element, wherein the second elements are elements of the equal type to the first element; and
sending the identification of the first element, an identification of at least one second element in the plurality of second elements, and target configuration information configured in the event tracking configuration page to a server, so that the server generates an event tracking configuration file corresponding to the page to be analyzed according to the identification of the first element, the identification of the at least one second element. and the target configuration information, wherein the event tracking configuration file is used to perform event tracking data collection on the page to be analyzed.

13. A non-transitory computer-readable storage medium, comprising instructions, wherein the instructions instruct a device to execute the method according to claim 1.

14. A non-transitory computer-readable storage medium, comprising instructions, wherein the instructions instruct a device to execute the method according to claim 9.

15. The event tracking processing device according to claim 12, wherein the identification of the first element comprises a path position of the first element, the path position comprises path information and first position information, the path information indicates that an element path of the first element comprises N levels, N is an integer greater than 1, and the first position information indicates a number corresponding to a tag name of the first element at each level,
wherein the N levels comprise a first level, the first level comprises at least one element having the tag name, and a number corresponding to the tag name of the first element at the first level indicates a number of the first element among the at least one element having the tag name, and the determining a plurality of second elements in the page to be analyzed according to the identification of the first element comprises:
replacing a first number in the first position information with a preset path wildcard to obtain second position information, wherein the preset path wildcard indicates that the first number is ignored; and
determining the plurality of second elements according to the second position information and the path information.

16. The event tracking processing device according to claim 15, wherein the replacing a first number in the first position information with a preset path wildcard to obtain second position information comprises:
sequentially replacing, in a preset order, numbers corresponding to respective levels in the N levels in the first position information with the preset path wildcard, to obtain the second position information corresponding to the respective levels, wherein the numbers corresponding to the respective levels in the first position information comprise the first number.

17. The event tracking processing device according to claim 12, wherein the identification of the first element comprises a first cascading style sheets (CSS) selector of the first element, and the determining a plurality of second elements in the page to be analyzed according to the identification of the first element comprises:
determining a candidate CSS selector according to the first CSS selector;
determining a relative CSS path between the first CSS selector and the candidate CSS selector; and
determining the plurality of second elements according to the candidate CSS selector and the relative CSS selector.

18. The event tracking processing device according to claim 17, wherein the determining a candidate CSS selector according to the first CSS selector comprises:
determining, through M rounds of iteration, a candidate CSS selector corresponding to each round of iteration, M is an integer greater than 1,
wherein, in a first round of iteration, determining a first parent CSS selector of the first CSS selector as a candidate CSS selector corresponding to the first round of iteration; and
in an ith round of iteration, determining a CSS selector having an inheritance relationship with a candidate CSS selector determined in an (i-1)th round of iteration as a candidate CSS selector corresponding to the ith round of iteration, wherein i is an integer greater than 1 and less than or equal to M.

19. The event tracking processing device according to claim 12, wherein the determining a plurality of second elements in the page to be analyzed according to the identification of the first element comprises:
determining the plurality of second elements in the page to be analyzed according to the identification of the first element, in response to an operation of automatically acquiring an element of an equal type triggered in the event tracking configuration page.

20. The event tracking processing device according to claim 12, wherein the method further comprises:
presenting the plurality of second elements; and
acquiring an identification of the at least one second element in response to a selection operation triggered for the at least one second element in the plurality of elements.

21. The event tracking processing device according to claim 12, wherein the target configuration information comprises one or more of the following:
an event type corresponding to the event tracking data collection, a trigger condition of the event tracking data collection, and an attribute value corresponding to an event tracking element, wherein the event tracking element comprises the first element and the at least one second element.
